(19) United States
(12) Patent Application Publication
(10) Pub. No.: US 2013/0047946 A1
(43) Pub. Date: Feb. 28, 2013

(54) LASER IGNITION SYSTEM

(71) Applicants: Rene Hartke, Stuttgart (DE); Andreas Letsch, Stuttgart (DE); Heiko Ridderbusch, Schwieberdingen (DE)

(72) Inventors: Rene Hartke, Stuttgart (DE); Andreas Letsch, Stuttgart (DE); Heiko Ridderbusch, Schwieberdingen (DE)

(21) Appl. No.: 13/515,456

(22) PCT Filed: Nov. 3, 2010
(86) PCT No.: PCT/EP2010/066704

§ 371 Date: Aug. 27, 2012

(51) Int. Cl. F02P 23/04

(52) U.S. Cl. 123/143 B; 701/102

(57) ABSTRACT

A laser device for a laser ignition system of an internal combustion engine includes a laser-active solid, an optical Q-switch, a first resonator in which at least the laser-active solid is situated, and a second resonator optically coupled to the first resonator. The length of the second resonator is set or modulated via actuators to optimize the ignition.

### BACKGROUND OF THE INVENTION

1. Field of the Invention

The present invention is directed to a laser ignition device and a method for operating a laser ignition device.

2. Description of the Related Art

An ignition device, which has a laser device having a laser-active solid, for an internal combustion is known from published international patent application document WO 2006/125685 A1. The laser device furthermore includes an optical Q-switch and a resonator, including an end mirror and an output mirror, in which the laser-active solid and the optical Q-switch are situated.

It is known that although extending the resonator in such a laser device results in that the focusability/radiation quality of the radiation generated by the laser device may be improved, the pulse duration of the generated laser radiation, however, simultaneously also increases, which is generally undesirable when using the generated radiation for igniting fuels.

However, although the pulse duration of the generated laser radiation may be reduced by shortening the resonator in such a laser device, but, at the same time, a deterioration of the focusability/radiation quality of the generated radiation must generally be accepted.

Overall the disadvantage remains that the pulse duration and the focusability cannot be optimized independently of one another.

### BRIEF SUMMARY OF THE INVENTION

Laser devices according to the present invention have the advantage over the related art that laser radiation may be generated which is satisfactorily focusable and may be generated in the form of very short pulses.

For this purpose, it is provided that the laser-active solid interacts with two optically coupled resonators which are configured in such a way that one of the resonators addresses the focusability property and the other one addresses the pulse duration property.

Resonators are understood to mean systems in each of which a standing wave is capable of forming. An optical resonator is understood to mean a system, in particular, which includes a total of at least two highly reflective or partially reflective mirrors which are situated spaced apart from one another, for example opposite one another, in the propagation direction of the light.

Two resonators are referred to as optically coupled when a standing wave is capable of forming in one of the resonators as a result of a crosstalk of a standing wave formed in the other one of the resonators. Optical resonators are, for example, optically coupled to one another when the resonators are formed from reflective surfaces all of which are aligned flatly and in parallel to one another, and along a common optical axis.

The mirrors which partially reflect the light to be generated by the laser device, also referred to here as partially reflective mirrors, are in the present case understood as mirrors which reflect 25% to 90%, in particular 40% to 80%, of this light. In differentiation to these mirrors, mirrors which reflect even more of this light, in particular more than 95%, are referred to as highly reflective mirrors.

One refinement of the present invention provides that the laser-active solid is situated both within the first and within the second resonator. This preferably also applies to the optical Q-switch.

Another refinement of the present invention provides that the second resonator is longer, in particular significantly longer, than the first resonator, for example at least 1.5 times or at least three times as long as the first resonator.

In this case, the longer resonator suppresses the formation of high transversal modes, thus resulting in good focusability. At the same time, the short resonator causes an excessive output of the generated laser radiation in the laser-active solid, whereby a population inversion, which has previously been generated in the laser-active solid with the aid of pumped light, may rapidly be reduced, thus resulting in a short pulse duration.

A similar effect results when the first resonator is situated within the second resonator. To achieve this effect, it is provided in this context in particular that the light circulating in the second resonator is intensified at the most in those parts of the second resonator in which the first resonator is situated. In other words: In this case, no additional laser-active material is present outside the first resonator. The space of the second resonator outside the first resonator may, for example, be filled with air or another gas and/or glass and/or with vacuum or with another material which does not absorb the light generated by the laser device or absorbs it only to a small extent (<1%).

In a particularly compact embodiment, the laser device has a particularly highly reflective end mirror which, together with a first, in particular partially reflective, output mirror forms the first resonator, and, together with a second, in particular partially reflective, output mirror, which is situated behind the first output mirror viewed from the laser-active solid in the propagation direction of the light, forms the second resonator. It is preferably provided in this case as well that the light circulating in the second resonator is intensified the most in those parts of the second resonator in which the first resonator is situated. In other words: Outside the first resonator, i.e., between the two output mirrors, no additional laser-active solid laser material is situated in this case. The space between the two output mirrors may, for example, be filled with air or another gas and/or glass and/or with vacuum or with another material which does not absorb the light generated by the laser device or absorbs it only to a small extent (<1%). If this space is filled with glass, the advantage of a particularly mechanically stable configuration additionally results. In this case, a monolithic embodiment of the laser device is possible in particular.

Studies by the applicant have shown that laser radiation having satisfactory focusability in short pulses occurs in particular when the reflectivity of the second output mirror for the light to be generated by the laser device is at least 1.5 times, in particular at least twice, as great as that of the first output mirror. If the reflectivity of the second output mirror is 45% (in particular 60%), the reflectivity of the first output mirror cannot be more than 30%.

Advantageously, as compared to known laser spark plugs, the number of the components does not have to be increased if at least one mirror, in particular at least one of the output mirrors, preferably the output mirror of the second resonator, is implemented as a reflective coating of the combustion chamber window or a lens of the laser spark plug.

To be able to optimize the cooperation of the coupled resonators, in particular as a function of temperature, it is provided in one refinement of the present invention that the laser spark plug includes activatable actuatory means, e.g., piezoelectric actuators, with the aid of which at least one mirror if shiftable, in particular in the propagation direction of the light, i.e., with the aid of which the length of at least one of the resonators is variable.

It is furthermore provided in the refinements of the present invention that the laser ignition system includes a combustion chamber sensor, e.g., a photo detector, a sound detector and/or a temperature detector and/or a spectrometer, and a control unit which is designed to receive signals from the combustion chamber sensor and to generate signals for activating the actuatory means.

It is provided that the signals from the combustion chamber sensor are evaluated, in particular by the control unit, with regard to at least one ignition property, e.g., the taking place of the ignition, the point in time of the ignition, the intensity of the ignition sparks and the flame core, or one combustion property, e.g., the occurrence of a concentration of harmful substances.

In one refinement of the present invention it is furthermore provided that during the operation of the internal combustion engine the detected property is at least occasionally optimized, preferably maximized or minimized, by activating the actuatory means.

### BRIEF DESCRIPTION OF THE DRAWINGS

FIG. 1 shows a schematic representation of an internal combustion engine having a laser ignition device.

FIG. 2 shows a laser device according to the present invention.

FIGS. 3, 4, and 5 show laser spark plugs according to the present invention.

FIG. 6 shows a laser ignition device according to the present invention.

### DETAILED DESCRIPTION OF THE INVENTION

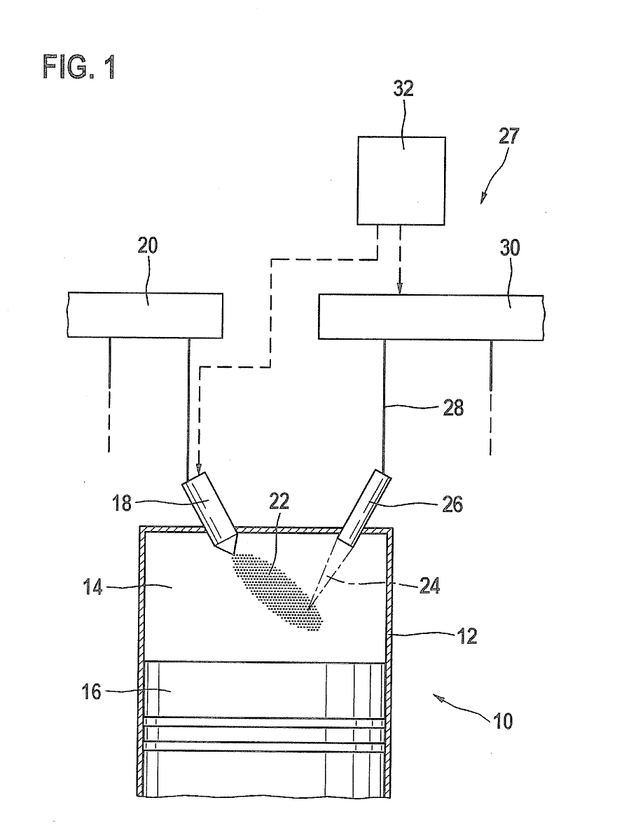

An internal combustion engine is identified overall with reference numeral 10 in FIG. 1. It is used for driving a motor vehicle (not illustrated) or as a stationary engine. Internal combustion engine 10 includes multiple cylinders, only one of which is labeled with reference numeral 12 in FIG. 1. A combustion chamber 14 of cylinder 12 is delimited by a piston 16. Fuel reaches combustion chamber 14 directly through an injector 18, which is connected to a fuel pressure storage device 20.

Fuel 22 injected into combustion chamber 14 is ignited with the aid of pulsed laser radiation 24 which is emitted into combustion chamber 14 by a laser ignition device 27 which includes a laser device 26. For this purpose, laser device 26 is supplied, via fiber optic device 28, with a pumped light generated by a pumped light source 30. Pumped light source 30 is controlled by a control and regulating device 32, which also activates injector 18.

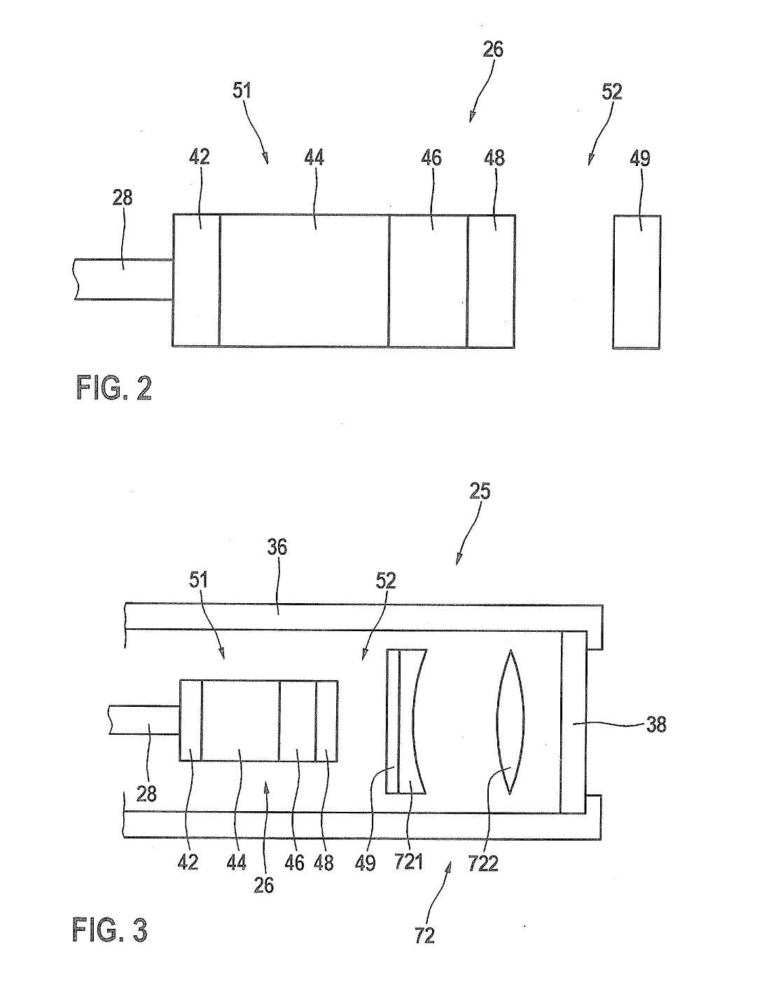

A first specific embodiment of a laser device 26 according to the present invention is shown in FIG. 2 and includes a first laser-active solid 44, an optical Q-switch 46, as well as a first output mirror 48, and an end mirror 42. The laser device further includes a second output mirror 49 which is situated at a distance from first output mirror 48.

First laser-active solid 44 is, for example, an Nd:YAG crystal, and optical Q-switch 46 is, for example, a Cr:YAG crystal which is connected monolithically, for example by wringing and bonding, to first laser-active solid 44. First output mirror 48 is implemented by a dielectric coating of optical Q-switch 46. It has a reflectivity of 30%, for example, for light of a 1064 nm wavelength. End mirror 42 is implemented by a dielectric coating of first laser-active solid 44. It has a reflectivity of at least 99% for light of a 1064 nm wavelength and is in addition highly transmitting for light of an 808 nm wavelength, i.e., only minor losses occur when light of this wavelength is transmitted into first laser-active solid 44. The reflective surfaces of first output mirror 48 and end mirror 42 are flat and situated in parallel to one another in this example and thus form a first resonator 51. It is, however, also possible to form a resonator using curved mirrors 42, 48 in a manner known per se.

Second output mirror 49 is implemented by a dielectric coating, for example on a glass substrate. It has a reflectivity of 65%, for example, for light of a 1064 nm wavelength. In this example, the reflective surface of second output mirror 49 is flat and in parallel to end mirror 42 together with which second output mirror 49 thus forms a second resonator 52. It is, of course, also possible to form an optical resonator using curved mirrors 42, 49 in a manner known per se.

In this example, first resonator 51 and second resonator 52 are designed and situated in such a way that, if a standing wave forms in one of resonators 51;52, this standing wave cross talks into the other resonator 52;51 so that a standing wave also forms in the other resonator 52;51. First resonator 51 and second resonator 52 are thus optically coupled to one another. In this example, the resonators are additionally optically coupled to one another in that they access the same laser-active medium. Optically coupled resonators 51, 52 may be implemented using other mirrors 42, 48, 49 than used in this example and by other arrangements of these mirrors 42, 48, 49.

While first resonator 51 is quite short in this example and has a length of 20 mm to 30 mm, for example, second resonator 52 is considerably longer and has a length of 100 mm, for example.

Laser device 26 is supplied with pumped light via a fiber optic device 28, for example via an optical fiber or a bundle of optical fibers, and by end mirror 42; the pumped light is focused within laser-active solid 44. Of course, it is also conceivable that the pumped light is supplied longitudinally from the opposite side or that the pumped light is supplied transversally to laser-active solid 44. The pumped light is in this example light of an 808 nm wavelength and is made available by a pumped light source 30, for example by a semi-conductor laser.

The space remaining between first output mirror 48 and second output mirror 49 remains empty in this example, i.e., it is filled with air or with another gas or with vacuum. Alternatively, it is also possible to fill this space with a solid which is at least largely transparent for the laser light, e.g., glass. In particular, it is also possible that the material filling this space represents overall a monolithic compound structure—together with output mirrors 48, 49, optical Q-switch 46, laser-active solid 44 and end mirror 42—which may, for example, be produced by bonding and coating.

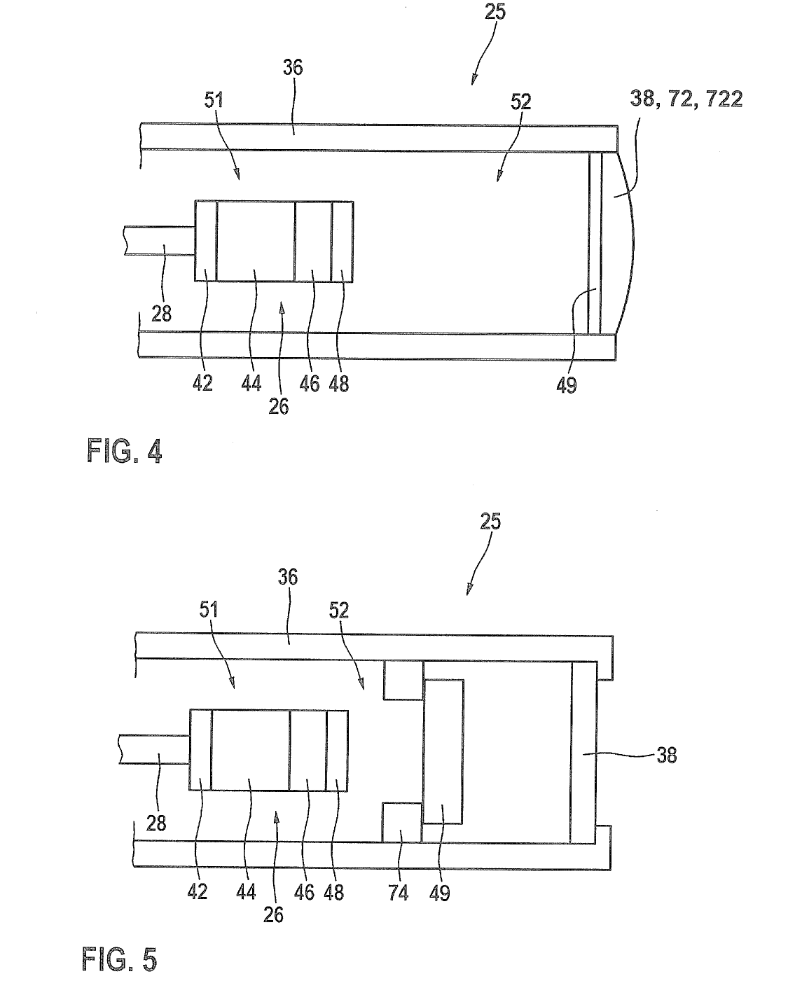

FIG. 3 shows a laser device 26 according to the present invention integrated into a laser spark plug 25 according to the present invention. It has a housing 36 in which, in addition to laser device 26, means for focusing 72 of radiation 24 to be generated by laser device 26, which include a diverging lens 721 and a collective lens 722 in this example, are situated. On the end side of housing 36, laser spark plug 25 further includes a combustion chamber window 38 which is provided to transmit radiation 24 generated by laser device 26 into a combustion chamber 14, the interior of laser spark plug 25 being protected by combustion chamber window 38 against environmental influences to be encountered in combustion chamber 14.

In this example, second output mirror 49 is implemented as a coating on one of the means for focusing 72 of radiation 24 to be generated by laser device 26, here on the side of diverging lens 721 facing laser-active solid 44. In alternative specific embodiments, other surfaces of lenses 721, 722 and the surfaces of combustion chamber window 38, in particular the side of combustion chamber window 38 facing laser-active solid 44, may be considered for this coating.

It is also possible, as shown in FIG. 4, to implement combustion chamber window 38 itself as the means for focusing 72 of radiation 24 to be generated by laser device 26, in particular as collective lens 722, and to implement second output mirror 49 as the coating of a surface of combustion chamber window 38, in particular of the side of combustion chamber window 38 facing laser-active solid 44.

Simultaneous implementation of a satisfactory focusability and a short pulse duration of generated radiation 24 in many cases requires that the lengths of first and second resonators 51, 52 be kept constant within tight limits, and/or requires exact precision in selecting these lengths. In laser spark plug 25 shown in FIG. 5, second output mirror 49 is connected for this purpose to housing 36 of laser spark plug 25 in a shiftable manner via activatable actuatory means 74, via at least one piezoelectric actuator.

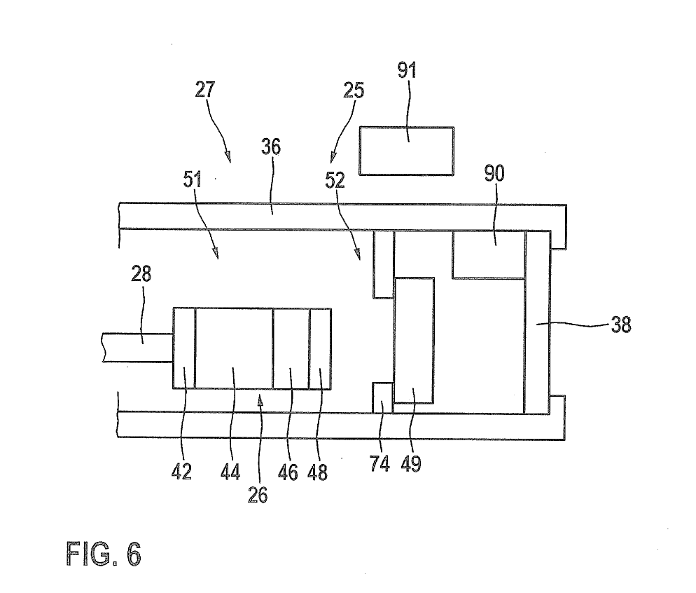

FIG. 6: In another exemplary embodiment, a laser spark plug 25 cooperates in a laser ignition system 27 with a combustion chamber sensor 90 (not illustrated), a photodiode in this case, and with a control unit 91. Combustion chamber sensor 90 detects in cooperation with control unit 91 the illumination intensity of an ignition spark to be generated by laser radiation 24. Furthermore, control unit 91 is designed to generate signals for activating the actuatory means. Control unit 91 is designed to activate actuatory means 74 in such a way that the brightness of the ignition spark to be generated is maximized. Strategies such as modulation strategies known per se are used here. It is, however, also possible to occasionally follow the entire actuator travel of actuatory means 74 during the operation of the laser ignition device and to determine a global maximum of the brightness of the ignition spark to be generated.

1-15. (canceled)

16. A laser device for a laser ignition system of an internal combustion engine, comprising:
a laser-active solid;
an optical Q-switch;
a first resonator in which the laser-active solid is situated; and
a second resonator optically coupled to the first resonator.

17. The laser device as recited in claim 16, wherein the laser-active solid is also situated in the second resonator.

18. The laser device as recited in claim 17, wherein the first resonator is situated within the second resonator in a propagation direction of light generated by the laser device.

19. The laser device as recited in claim 18, wherein internal space of the second resonator not occupied by the first resonator is filled with at least one medium which is transparent for the light generated by the laser device, wherein the at least one medium includes at least one of gas, glass and vacuum.

20. The laser device as recited in claim 17, wherein the laser-active solid is entirely located within the first resonator and also entirely located within the second resonator.

21. The laser device as recited in claim 20, wherein:
the first resonator includes an end mirror and a first output mirror; and
the second resonator includes the end mirror and a second output mirror situated behind the first output mirror when viewed from the laser-active solid in the propagation direction of the light.

22. The laser device as recited in claim 21, wherein:
the end mirror is highly reflective for the light generated by the laser device; and
the first and second output mirrors are partially reflective for the light generated by the laser device.

23. The laser device as recited in claim 21, wherein:
the space between the first and second output mirrors is filled with at least one medium which is transparent for the light generated by the laser device, wherein the at least one medium includes at least one of gas, glass and vacuum; and
no laser-active material is situated between the first and second output mirrors.

24. The laser device as recited in claim 21, wherein the reflectivity of the second output mirror for the light generated by the laser device is at least 1.5 times greater than the reflectivity of the first output mirror.

25. The laser device as recited in claim 21, wherein the length of the second resonator in the propagation direction of the light generated by the laser device is at least 1.5 times greater than the length of the first resonator in the propagation direction of the light.

26. A laser spark plug for a laser ignition system of an internal combustion engine, comprising:
a laser device including a laser-active solid, an optical Q-switch, a first resonator in which the laser-active solid is situated, and a second resonator optically coupled to the first resonator, wherein the first resonator is situated within the second resonator in a propagation direction of light generated by the laser device;
a housing having a combustion chamber window; and
a focusing unit for focusing the light generated by the laser device.

27. The laser spark plug as recited in claim 26, wherein at least one mirror associated with at least one of the first and second resonators is made of at least one coating applied to one of the combustion chamber window or the focusing unit.

28. The laser spark plug as recited in claim 26, wherein at least one mirror associated with at least one of the first and second resonators is connected to the housing in a movable manner via an actuator.

29. A laser ignition system for an internal combustion engine, comprising:
a laser spark plug including:
a laser device having a laser-active solid, an optical Q-switch, a first resonator in which the laser-active solid is situated, and a second resonator optically coupled to the first resonator, wherein the first resonator is situated within the second resonator in a propagation direction of light generated by the laser device;
a housing having a combustion chamber window; and
a focusing unit for focusing the light generated by the laser device;
wherein at least one mirror associated with at least one of the first and second resonators is connected to the housing in a movable manner via an actuator;
a combustion chamber sensor; and
a control unit configured to receive signals from the combustion chamber sensor and to generate signals for activating the actuator.

30. A method for igniting a fuel in an internal combustion engine, comprising:
providing a laser ignition system including:
a laser spark plug having:
a laser device including a laser-active solid, an optical Q-switch, a first resonator in which the laser-active solid is situated, and a second resonator optically coupled to the first resonator, wherein the first resonator is situated within the second resonator in a propagation direction of light generated by the laser device;
a housing having a combustion chamber window; and
a focusing unit for focusing the light generated by the laser device;
wherein at least one mirror associated with at least one of the first and second resonators is connected to the housing in a movable manner via an actuator;
a combustion chamber sensor; and
a control unit configured to receive signals from the combustion chamber sensor and to generate signals for activating the actuator;
detecting, with the aid of the combustion chamber sensor, the properties of at least one of ignition and combustion of the fuel; and
optimizing, by activating the actuator, the detection of the properties of at least one of ignition and combustion of the fuel.
